(19) United States
(12) Patent Application Publication
(10) Pub. No.: US 2024/0128761 A1
(43) Pub. Date: Apr. 18, 2024

(54) DOCKING STATIONS FOR MOBILE ENERGY STORAGE UNITS

(71) Applicant: NOMAD TRANSPORTABLE POWER SYSTEMS, INC., Waterbury, VT (US)

(72) Inventors: Jonathan Edward Bellows, Waterbury, VT (US); Gregg Richard Noble, Saxtons River, VT (US); Stephen P. Hoskins, Waterbury Center, VT (US); Margaret May Dobroth, Bolton, VT (US); Samuel Andrew Gavett, Waitsfield, VT (US); Alex David Perkins, North Ferrisburgh, VT (US)

(73) Assignee: NOMAD TRANSPORTABLE POWER SYSTEMS, INC., Waterbury, VT (US)

(21) Appl. No.: 18/546,747

(22) PCT Filed: Feb. 16, 2022
(86) PCT No.: PCT/US22/16624

§ 371 Date: Aug. 16, 2023

Related U.S. Application Data
(60) Provisional application No. 63/150,151, filed on Feb. 17, 2021.

(51) Int. Cl. H02J 3/32; H02J 7/00

(52) U.S. Cl. CPC H02J 3/322; H02J 7/00036; H02J 2207/20; H02J 2310/48

(57) ABSTRACT

An example of an apparatus to connect a power distribution network with an energy storage unit. The apparatus includes a mobile platform. In addition, the apparatus includes a connection system to connect with an energy storage unit and to receive a current from the energy storage unit. Furthermore, the apparatus includes a transformer mounted on the mobile platform to convert the voltage from the connection system to the voltage of a power distribution network. The apparatus also includes an output cable to connect with the power distribution network.

### CROSS REFERENCE TO RELATED APPLICATIONS

This application claims priority to and the benefit of U.S. Provisional Patent Application No. 63/150,151 which was filed on Feb. 17, 2021.

### BACKGROUND

Electricity and the ability to have access to a stable source of power plays a significant role in industrial development, economic development, and for personal use in daily life. Electricity may be generated to supply a power system or power grid. The demand of the power grid may fluctuate through time, in short intervals such as throughout the day, or over longer periods of time such as seasons of the year. For example, air conditioning energy loads may increase the amount of demand for electricity for the grid during the summer months or during times when large crowds form, such as during a festival. By contrast, this demand may vanish in the winter months. When the demand for electricity increases, the supply of electricity may not be able to be increased beyond an infrastructure limit. Accordingly, energy sources, such as generating stations are typically designed to provide the peak electricity demanded. When the demand exceeds this amount, the power system may not be able to maintain the specified power for the demanded load resulting in brownouts, blackouts, or increases in power costs as the supplier adjusts and purchases electricity from the active, open market. To meet this demand, building additional infrastructure, such as additional generating capacity is often the solution.

Energy storage systems may be used at the utility-scale to balance electricity supply and demand. In particular, lithium-ion batteries provide a high energy efficiency, long cycle life, and high energy density storage platform. Due to the weight and safety issues associated with moving charged utility-scale lithium-ion batteries, they are generally shipped in an uncharged and non-racked state to a location to be installed and charged for use. Accordingly, these utility-scale energy storage systems are generally at a fixed location and involve significant assembly and disassembly processes when the batteries are moved from one location to another. In practice, this generally means that lithium-ion batteries are only deployable at a specific location connected to one point on an electric grid where they remain for an extended period of time, for example, for 10-20 years.

### SUMMARY

In accordance with an aspect of the invention, an apparatus is provided. The apparatus includes a mobile platform. The apparatus further includes a connection system to connect with an energy storage unit The connection system is to receive a current from the energy storage unit. In addition, the apparatus includes a transformer mounted on the mobile platform. The transformer is to convert a first voltage from the connection system to a second voltage of a power distribution network. The apparatus also includes an output cable to connect with the power distribution network.

The connection system may include an inverter. The current from the energy storage unit may be a direct current and the inverter may be used to convert the direct current to alternating current.

The apparatus may further include a power line connector disposed on the output cable. The power line connector may be to connect the output cable to a power line of the power distribution network. The power line connector may be a tap connector to tap the power line.

The apparatus may additionally include a guide to mount the output cable to a utility pole. The guide may be a conduit for the output cable to pass therethrough.

The mobile platform may be a truck. The mobile platform may be a trailer to be towed by a truck.

In accordance with another aspect of the invention, another apparatus is provided. The apparatus includes a mobile platform. The apparatus further includes an energy storage unit mounted to the mobile platform. The energy storage unit is to store energy at a utility-scale to be provided to a power distribution network. In addition, the apparatus includes an output cable to connect with a power line of the power distribution network.

In accordance with another aspect of the invention, another method is provided. The method involves delivering a connection system and a transformer mounted on a mobile platform to a location. The method further involves receiving power from an energy storage unit at the connection system. In addition, the method involves converting a first voltage provided by the connection system to a second voltage for a power distribution network with the transformer. The method also involves providing the power at the second voltage to the power distribution network via an output cable.

### BRIEF DESCRIPTION OF THE DRAWINGS

Reference will now be made, by way of example only, to the accompanying drawings in which:

FIG. 1 is a side view representation of an example of an apparatus to connect a power distribution network with an energy storage unit;

FIG. 2 is a representation of a system using the apparatus of FIG. 1 to connect a power distribution network with an energy storage unit;

FIG. 3 is a representation of an example of an apparatus to connect to a power distribution network to provide power;

FIG. 4 is a side view representation of another example of an apparatus connected to a power distribution network and to connect with an energy storage unit;

FIG. 5 is a side view representation of another example of an apparatus connected to a power line and to connect with an energy storage unit;

FIG. 6 is a side view representation of another example of an truck to connect a power distribution network with an energy storage unit; and

FIG. 7 is a flowchart of an example of a method of connecting a power distribution network with an energy storage unit to provide power.

### DETAILED DESCRIPTION

The demand for electricity may often fluctuate to create imbalances between power generation and power consumption. In particular, instantaneous demand for electrical energy is often unpredictable from day to day and may depend on various factors such as temperature, industrial manufacturing changes, and seasonal variations. Since electricity storage is generally not used, the variations may result in challenges to the power distribution network in terms of electricity generation and distribution. To address this issue, a utility-scale energy storage system may be installed in the power distribution network, such as a power grid, to convert and store electricity from an energy source, such as a generator, and to subsequently convert it back into electrical energy to be re-supplied into the power distribution network. In some examples, additional electrical energy above the generation rate of power distribution network may be provided during peak demand periods. During these periods, an energy storage system that has been pre-charged with power may supplement the electricity supplied in the power distribution network.

As another example, a power distribution network may be severed or otherwise disconnected from a power generation station during a natural disaster. In some examples, the power generation station itself may be damaged or taken offline by a disaster, an accident, or other malfunction. In such a case, portions of a power distribution network or the entire power distribution network may be offline resulting in a loss of electricity to endpoints served by the power distribution network. In some cases, the damage that resulted in the power outage may be significant and not easily repaired and result in a long period of time without power. This may result in significant damage of equipment that uses electricity, such as loss of perishable foods stored in a refrigerator, climate control systems, sump pumps, etc.

Although batteries are now commonly used to provide portable electrical energy on a small scale such as to power electric cars and other apparatus, such as portable equipment at a remote work site, utility-scale energy storage systems, such as systems with a capacity greater than about 200 kilowatt-hours are typically stationary by design. In particular, utility-scale energy storage systems cannot be transported safely while in a charged or operational state due to the large amount of energy stored, the weight of the batteries, and the inertial forces which act upon them during transit. An accident during transportation may result in a catastrophic event. Accordingly, the batteries for utility-scale energy storage solutions are generally transported in a safer non-operational state, or de-racked state. Therefore, the energy storage system is to be installed or racked up at the final location to be installed in a fixed facility. Prior to moving the batteries of a utility-scale energy storage system, the batteries are to be de-racked and converted into a non-operational state for safe transportation.

Portable energy storage systems generally involve moving mobile energy storage units from one location to another. At each location, a mobile energy storage unit is to be connected to a power distribution network for grid-connected solutions or directly to a circuit supporting the electric load for off-grid connected solutions. The connection generally involves manually connecting a cable directly to the mobile energy storage unit. The cable may be connected directly to the power distribution network in some systems where the mobile energy storage unit generates power output in a form directly usable by the power distribution network. In other systems, the cable may be connected to an interface to convert the power output of the mobile energy storage unit into a form useable by the power distribution network. As an example, a mobile energy storage unit may typically include battery cells which provide direct current to be converted to AC current prior to transmission across most power distribution networks. In addition, such portable energy storage systems generally require special assembly making deployment on short notice to a location without existing infrastructure difficult.

An apparatus is provided to connection point for a mobile utility-scale energy storage unit to transfer energy from the mobile utility-scale energy storage unit to a power distribution network. The apparatus is to be delivered to a location at the power distribution network and include means to allow a connection to be made between the mobile energy storage unit and the power distribution network. The apparatus further allows for the connecting and disconnecting of the mobile energy storage unit quickly and safely when the mobile energy storage unit is depleted so that it may be moved to a location where the mobile energy storage unit may be charged, such as proximate to a power generation station. In particular, the apparatus may include a standardized connector to allow for quick connections with multiple energy storage units of varying energy capacities and power output levels so that when a mobile energy storage unit is removed for charging, another energy storage unit may be used to replace it with minimal downtime. By connecting multiple energy storage units to the power distribution network, changes may also be made without any downtime whatsoever. In the present examples, the energy storage unit may be moved from a location to another similar apparatus at another location in an operational state without having to prepare the energy storage unit for transportation. Accordingly, the apparatus allows for the rapid deployment of energy storage units to any location where to which the apparatus may be moved, such as by road. The installation of the apparatus to the power distribution network is simple may be done without any specialized training. Accordingly, the person delivering the apparatus may install it to the power distribution network.

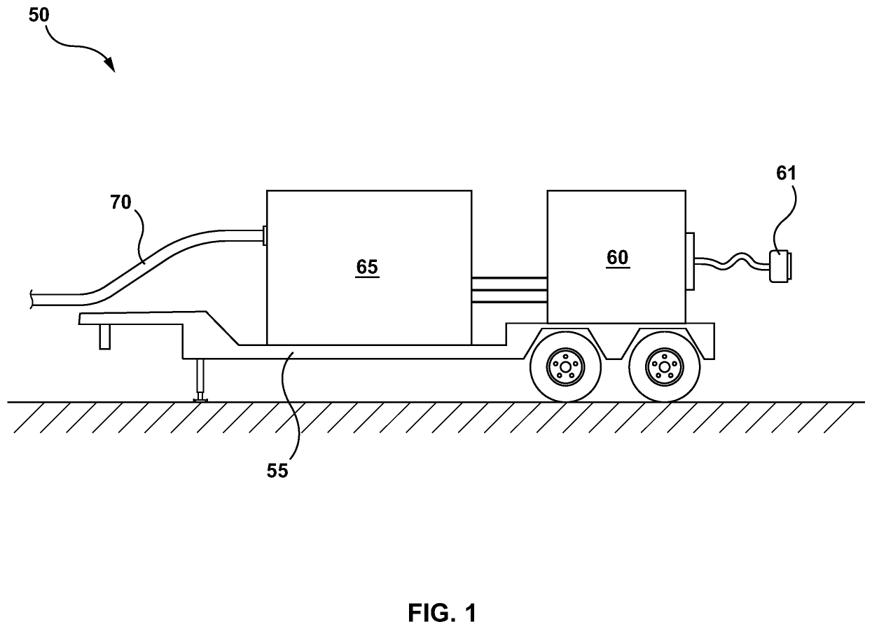

Referring to FIG. 1, an apparatus to connect a power distribution network with an energy storage unit is generally shown at 50. The apparatus 50 may include additional components, such as various additional interfaces and/or input/output devices such as indicators to interact with a user of the apparatus 50. The interactions with the user may include viewing the operational status of the apparatus 50 or the system in which the apparatus 50 operates, such as the status of the mobile utility-scale energy storage unit or the status of the power distribution network. Accordingly, the apparatus 50 may also include additional sensors and controls to facilitate the connection with the mobile energy storage unit. In the present example, the apparatus includes a mobile platform 55, a connection system 60, a transformer 65, and an output cable 70.

The mobile platform 55 is to transport the apparatus 50 from one location to another location. For example, the mobile platform 55 may be used to deliver the apparatus 50 to a power distribution network that is offline, such as due to a natural disaster, where the delivery time may be shorter than the time for restoration. In other examples, the apparatus 50 may be delivered on the mobile platform 55 to a remote location where a temporary site is being built, such as at a natural resource site, or a festival site. The mobile platform 55 is also not particularly limited and may include any structure capable of safely transporting the components of the apparatus 50 between different locations. In the present example, the mobile platform 55 is a trailer unit to be towed by a tractor unit. The mobile platform 55 may be parked proximate to an access point to a power distribution network, such as a transformer box or transmission wire.

It is to be appreciated that in other examples, the mobile platform 55 may include an engine unit such that the apparatus 50 may be driven to a new location without a separate tractor unit. In further examples, the mobile platform 55 may be a rail car or placed on a rail car to be transported by train to a location. Further examples may include the mobile platform 55 being substituted with a flotation device, such as on a barge.

The connection system 60 is to connect with an energy storage unit that has been delivered to provide power to the power distribution network. In the present example, the connection system 60 may include a connector 61 to connect with the energy storage unit. The connector 61 is not particularly limited and may include any connection mechanism that can quickly form an electrical connection with the energy storage unit. Accordingly, the connection system 60 is to connect to the energy storage unit and receive a current to be passed onto the power distribution network Although the present example illustrates a cable with the connector 61 disposed at an end to connect with the energy storage unit, it is to be appreciated by a person of skill with the benefit of this description that in other examples, the connection system 60 may not include the connector 61 and instead include a receptacle to receive a connector from the energy storage unit.

In the present example, the utility-scale energy storage unit that connects to the connection system 60 provides direct current from battery packs. The voltage and current provided by the energy storage unit is not particularly limited and may be varied depending on the size of the energy storage unit as well as its application. Accordingly, in the present example, the connection system 60 may include electronics to control the flow of electricity from the energy storage unit and to convert the energy into a form that is useable by the power distribution network, which typically operates by providing alternating current power to end users. In examples where the utility-scale energy storage unit provides direct current power, the connection system 60 may include further electronics to provide compatible power for the power distribution network, such as an inverter to convert the direct current power to alternating current power. It is to be appreciated that the connection system 60 is not particularly limited and that in other examples, the connection system 60 may be nothing more than a cable directly connecting the transformer 65 to the energy storage unit when no intervening electronics are to be used and that the power provided by the energy storage unit is in a suitable form for the transformer 65.

In some examples, the connection system 60 may have an additional direct current inputs, such as a solar array to provide additional power to the power distribution network or to power local electronics. In some examples, the connection system 60 may also have an additional alternating current input for a conventional gas, diesel, natural gas generator, or wind turbine. The additional power inputs of the connection system 60 may also provide a centralized point of interconnection for both the mobile storage unit and onsite electricity generation to charge the mobile energy storage unit to a limited amount.

In the present example, the transformer 65 is to be mounted on the mobile platform 55 to receive an alternating current from the connection system 60 at a voltage and to provide current to the power distribution network at a different voltage. In the present example, it may be assumed for the purposes of illustration that the connection system 60 provides 480 VAC to the transformer 65. In this example, the transformer 65 may be used to adjust the voltage (i.e. step up or step down) to match the voltage of a power line of the power distribution network. The voltage to be provided to the power distribution network is not particularly limited. For example, the transformer 65 may be configured to step up the voltage from 480 VAC to 13200 VAC for transmission across a high voltage power line of the power distribution network. In other examples, the transformer 65 may be configured to step up the voltage from 480 VAC to 34500 VAC for transmission across another high voltage power line of the power distribution network at a higher voltage. The transformer 65 may also be used to step down the voltage from 480 VAC to 110 VAC or 230 VAC for delivery to a consumer site such as an office building or a plurality of residential buildings. It is to be appreciated by a person of skill with the benefit of this description that the transformer 65 may be configured to accommodate additional voltages or multiple voltages depending on the specific application and location where the apparatus 50 is to be delivery and connected. Accordingly, the transformer 65 may be configured to accommodate the interconnection voltage of an electric grid or end-user service in the case of an off-grid solution. Although the above examples illustrate an input of 480 VAC from the connection system 60, other examples may have an input with a different voltage.

The cable 70 extends from the transformer 65 to connect to the power distribution network. Accordingly, power may be transferred from the apparatus 50 to the power distribution network via the cable 70. It is to be appreciated by a person skilled in the art, that the cable 70 is not particularly limited and may be part of a plurality of cables connecting the transformer 65 to a single connection point or multiple connection points of the power distribution network. The cable 70 is not particularly limited and is to be sufficiently rated for the currents that are to be delivered to the power distribution network. The manner by which the cable 70 connects to the power distribution network is not particularly limited. For example, the cable 70 may be plugged into a transformer box of the power distribution network or tapped into a power line of the power distribution network.

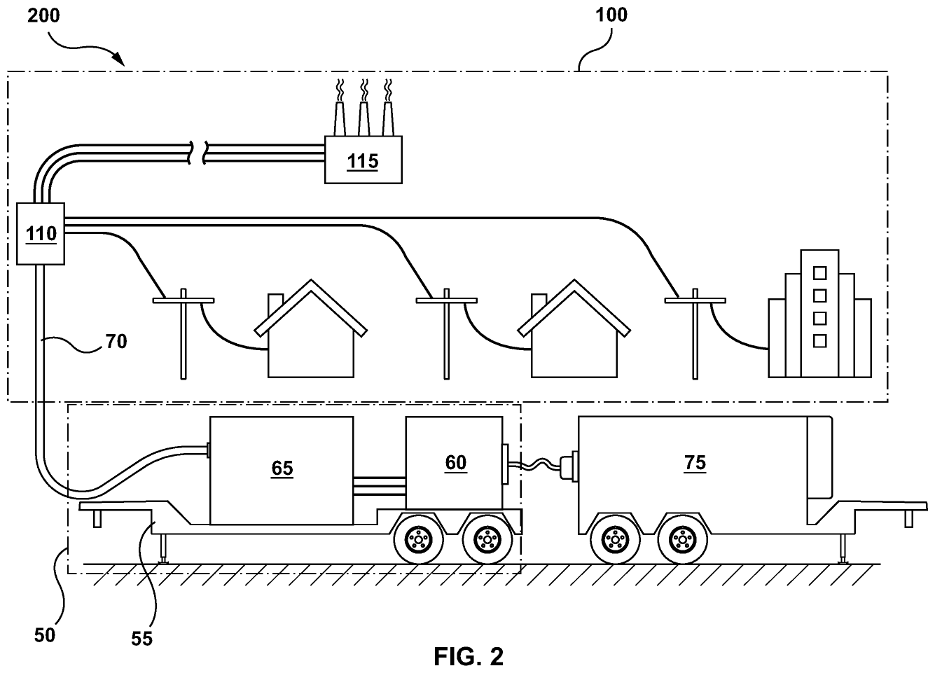

Referring to FIG. 2, an example of a system 200 using the apparatus 50 to connect a power distribution network 100 with an energy storage unit 75 is generally shown. In the present example, the apparatus 50 is to provide a connection mechanism for the energy storage unit 75 to the power distribution network 100 during periods where the power source for the power distribution network 100 cannot meet demand or if the power source is offline due to a disaster, an accident, or other malfunction. It is to be appreciated that the energy storage unit 75 and the power distribution network 100 are not limited and variations capable of performing the design functions may be substituted.

As shown, the apparatus 50 may be delivered to a location proximate to a transformer box 110 of the power distribution network 100. The apparatus 50 is then parked and connected to the power distribution network 100. In the present example, the cable 70 is to be connected to the transformer box 110 of the power distribution network 100. The manner by which the cable 70 is connected is not particularly limited. For example, the transformer box 110 may include a connector compatible with the cable 70. In other examples, the cable 70 may be connected to the same cable coming from power station 115. Once the apparatus 50 is connected to the power distribution network 100, the energy storage unit 75 may be delivered to the site and connected to the apparatus 50. Once connected, the energy storage unit 75 may then be used to supply power to the power distribution network 100 to restore power or supply additional power during peak demand times.

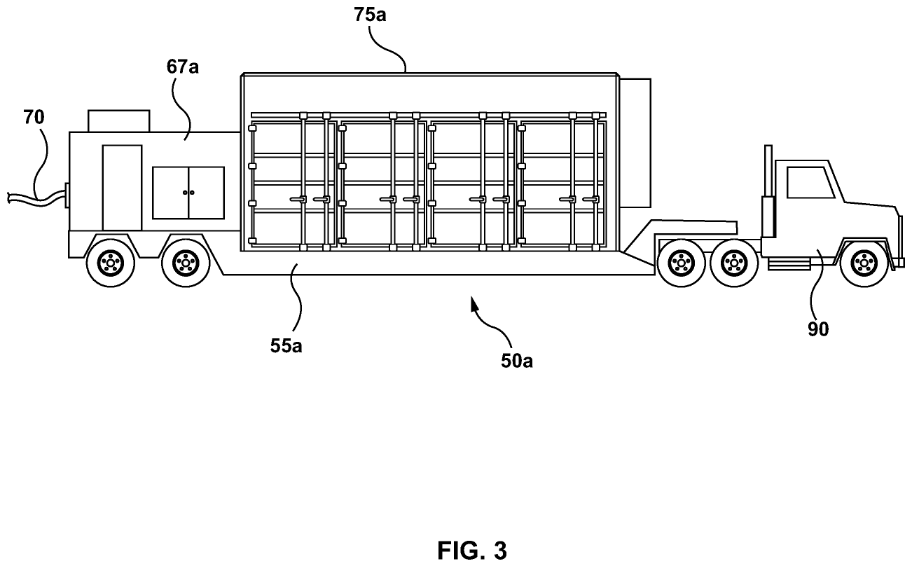

Referring to FIG. 3, an example of an apparatus 50a to connect to a power distribution network to provide additional power or to provide power is general shown. Like components of the apparatus 50a bear like reference to their counterparts in the apparatus 50, except followed by the suffix “a”. It is to be appreciated by a person of skill with the benefit of this description that apparatus 50a is not limited and may include additional components, such as those discussed above in connection with the apparatus 50. For example, the apparatus 50a may also include additional sensors and controls to assist with the connection to the power distribution network or the positioning of the apparatus 50a. In the present example, the apparatus 50a includes a mobile platform 55a, an output cable 70a, and an energy storage unit 75a.

The mobile platform 55a is to transport the apparatus 50a from one location to another location. For example, the mobile platform 55a may be used to deliver the apparatus 50a to a power distribution network that is offline, such as due to a natural disaster. The mobile platform 55a is also not particularly limited and may include any structure capable of safely transporting the components of the apparatus 50a between different locations. In the present example, the mobile platform 55a is a trailer unit to be towed by a tractor unit 90. The mobile platform 55a may support an energy storage unit 75a and a control room 67a.

In the present example, the energy storage unit 75a is to store energy at a utility-scale to provide a power distribution network with electrical energy. For example, the energy storage unit 75a may include a plurality of lithium-ion batteries, such as a plurality of KORE MARK 1 lithium-ion batteries. Accordingly, the energy storage unit 75a may be connected to a power distribution network quickly via the cable 70a to provide power relatively quickly after being delivered to the power distribution network.

The specifications of the energy storage unit 75a is not particularly limited and may be modified to accommodate a wide variety of applications. For example, the energy storage unit 75a may provide utility-scale energy storage with a capacity of over about 1.2 megawatt-hours. As another example, the energy storage unit 75a may include additional battery cells to provide a storage capacity of about 2.0 megawatt-hours or about 2.4 megawatt-hours. The rate at which the energy may be supplied to the power distribution network is also no limited and the energy storage unit 75a may discharge power at up to about 500 kilowatts in some examples. In other examples, the energy storage unit 75a may discharge power at higher rates of up to about 1 megawatt or greater. The energy storage unit 75a may also discharge at lower rates of power by de-rating the onboard power conversion system through the system supervisory controller to outputs as low as about 100 kilowatts.

In some examples, the control room 67a is to house control systems and electrical components of the apparatus 50a. For example, the control room 67a may house a connection system with an inverter to convert direct current from an energy storage unit 75a to an alternating current to be delivered to provide power to the power distribution network. In addition, the control room 67a may also house a transformer to receive an alternating current at a voltage and to provide alternating current to the power distribution network at a different voltage, which may be higher or lower than the original voltage received.

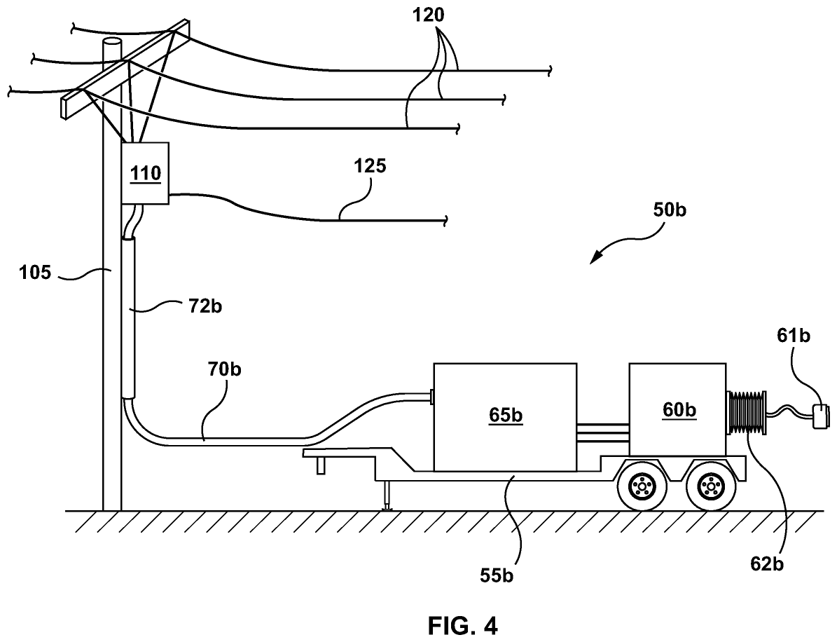

Referring to FIG. 4, another example of an apparatus 50b to connect a power distribution network with an energy storage unit is generally shown. Like components of the apparatus 50b bear like reference to their counterparts in the apparatus 50, except followed by the suffix “b”. It is to be appreciated by a person of skill with the benefit of this description that apparatus 50b is not limited and may include additional components, such as those discussed above in connection with the apparatus 50. In the present example, the apparatus includes a mobile platform 55b, a connection system 60b, a transformer 65b, and an output cable 70b.

In the present example, the connection system 60b is to connect with an energy storage unit that has been delivered to provide power to the power distribution network. The connection system 60b includes a connector 61b to connect with the energy storage unit. In addition, the connection system 60b includes a cover 62b to protect the connector 61b during operation from the elements. In addition, the cover 62b provides an extra layer of security to deter tampering and to reduce the possibility of accidental contact that may cause electrocution. In the present example, the cover 62b is an extendable bellows connected to an enclosure of the connection system 60b at one end and with the mobile utility-scale energy storage unit at the other end. The cover forms a weatherproof seal such that the connector 61b is not exposed to the external environment. It is to be appreciated by a person of skill with the benefit of this description that there are several advantages to providing a space protected from the weather elements. For example, since the space is protected from the elements such as moisture and wind, standard electrical components may be used instead of specialized weatherproof components.

The cable 70b extends from the transformer 65b to connect to the power distribution network. In the present example, the power distribution network includes high voltage power lines 120 supported by a utility pole 105. A transformer box 110 is also disposed on the utility pole 105 to step down voltage from the high voltage power lines 120 to a lower voltage to be delivered via the power line 125 to end consumers. In the present example, the cable 70b is plugged into a transformer box 110 of the power distribution network.

The apparatus 50b may also include a guide 72b mounted on the utility pole to guide the cable 70b to the transformer box 110 along the length of the utility pole 105. It is to be appreciated by a person of skill with the benefit of this description that the guide 72b is not particularly limited. In the present example, the guide 72b is a conduit through which the cable 70b can pass. In other examples, the guide 72b may be a clip or a series of clips to hold the cable 70b along length of the utility pole 105.

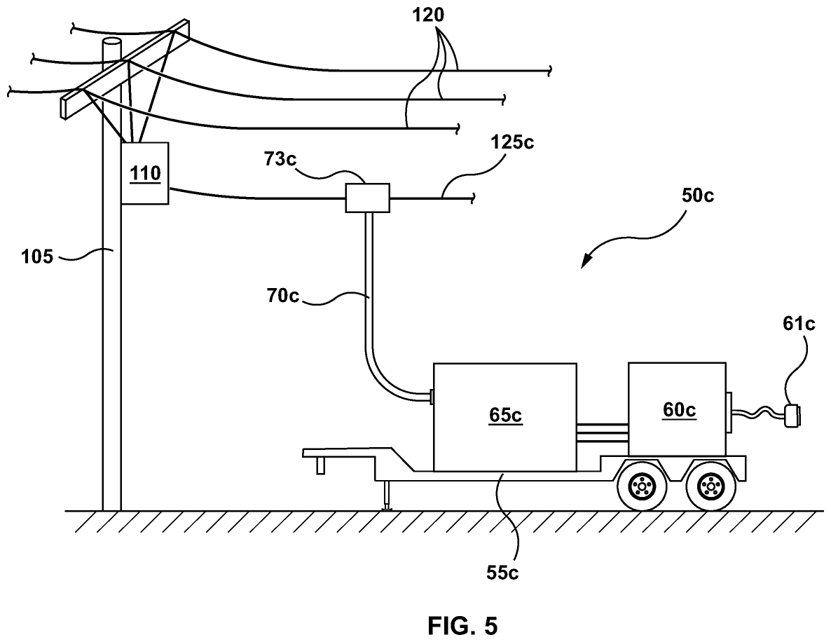

Referring to FIG. 5, another example of an apparatus 50c to connect a power distribution network with an energy storage unit is generally shown. Like components of the apparatus 50c bear like reference to their counterparts in the apparatus 50b, except followed by the suffix “c”. In the present example, the apparatus includes a mobile platform 55c, a connection system 60c, a transformer 65c, and an output cable 70c.

In the present example, a power line connector 73c is disposed at an end of the cable 70c. The power line connector 73c is to connect the cable 70c to the power line 125 of the power distribution network. Accordingly, the power line connector 73c provides an electrical connection from the transformer 65c to the power distribution network. The power line connector 73c is not limited and may include a variety of different connectors. In the present example, the power line connector 73c may be a tap connector to tap into the power line 125. In other examples, the power line connector 73c may be a clamping u-bolt. In another example, the power line connector 73c may be a fixed grip or detachable spring clamping mechanism.

It is to be appreciated by a person of skill with the benefit of this description that by providing a power line connector 73c to connect to any power line, the apparatus 50c is versatile and can be connected to any portion of a power distribution network. For example, the power line connector 73c may be connected to the power line 120 in some examples or another portion of the power distribution network to provide power.

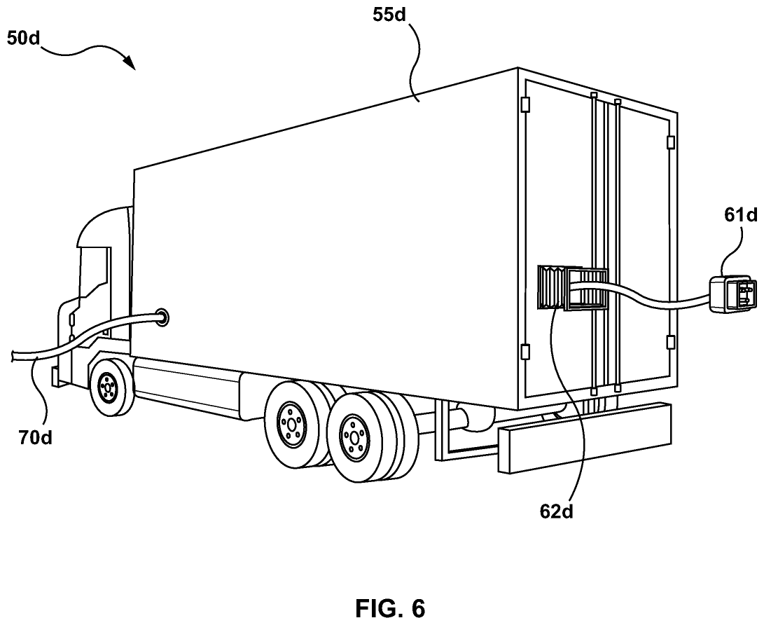

Referring to FIG. 6, another example of an apparatus 50d to connect a power distribution network with an energy storage unit is generally shown. Like components of the apparatus 50d bear like reference to their counterparts in the apparatus 50b, except followed by the suffix “d”. It is to be appreciated by a person of skill with the benefit of this description that apparatus 50d is not limited and may include additional components, such as those discussed above in connection with the apparatus 50b. In the present example, the apparatus includes a mobile platform 55b, a connector 61d, a cover 62d, and an output cable 70b.

In the present example, the mobile platform 55d is a truck. Accordingly, the apparatus 50d may be moved between locations without a tractor to provide a tow. It is to be appreciated that this provides an advantage of mobility without having to schedule a tractor to move the apparatus 50d.

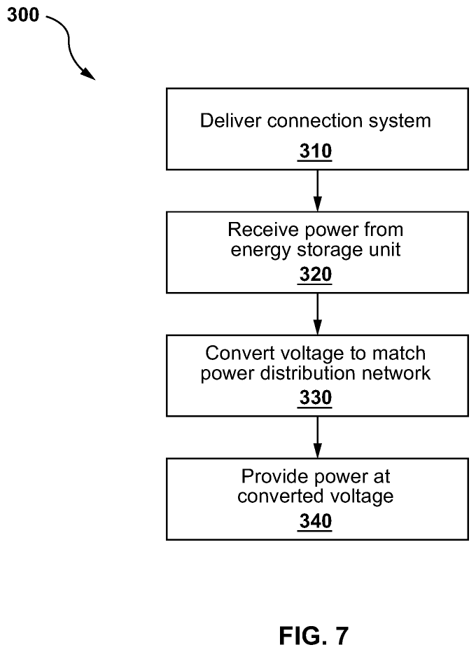

Referring to FIG. 7, a flowchart of a method of connecting a power distribution network with a mobile utility-scale energy storage unit is generally shown at 300. In order to assist in the explanation of method 300, it will be assumed that method 300 may be performed by the apparatus 50. Indeed, the method 300 may be one way in which the apparatus 50 may be operated. Furthermore, the following discussion of method 300 may lead to a further understanding of the apparatus 50 and its components. In addition, it is to be emphasized, that method 300 may not be performed in the exact sequence as shown, and various blocks may be performed in parallel rather than in sequence, or in a different sequence altogether.

Beginning at block 310, an apparatus 50 with a connection system 60 and a transformer 65 is to be delivered to a location where power is to be provided to a power distribution network. The apparatus 50 is to be connected to the power distribution network and to receive an energy storage unit. Once connected, the apparatus is to receive power from the energy storage unit at block 320 via the connection system 60. The transformer 65 converts the voltage of the current from the connection system to match the voltage of the power distribution system at block 330 so that the apparatus 50 can provide substitute power at the same voltage to avoid any reconfiguration of the power distribution network. The apparatus 50 then provides the power to the power distribution network at block 340.

It is to be appreciated by a person of skill with the benefit of this description that connecting the apparatus 50 to the energy storage unit provides a connection between the power distribution network and the energy storage unit to allow for transfer of energy therebetween. The connector 61 further allows the energy storage unit to be switched when depleted so that power may be provided to the power distribution network with few disruptions.

Various advantages will now become apparent to a person of skill with the benefit of this description. In particular, the apparatus 50 may be used to provide a standardized interconnection interface for mobile utility-scale energy storage units at a location where power can be supplied to a power distribution network. The mobile utility-scale energy storage unit is not limited and the apparatus 50 may be configured to connect with different models of the mobile utility-scale energy storage unit with different capacities and power ratings.

It should be recognized that features and aspects of the various examples provided above may be combined into further examples that also fall within the scope of the present disclosure.

1. An apparatus comprising:
a mobile platform;
a connection system to connect with an energy storage unit, wherein the connection system is to receive a current from the energy storage unit;
a transformer mounted on the mobile platform, wherein the transformer is to convert a first voltage from the connection system to a second voltage of a power distribution network; and
an output cable to connect with the power distribution network.

2. The apparatus of claim 1, wherein the connection system includes an inverter, and wherein the current from the energy storage unit is a direct current, the inverter to convert the direct current to alternating current.

3. The apparatus of claim 1, further comprising a power line connector disposed on the output cable, wherein the power line connector is to connect the output cable to a power line of the power distribution network.

4. The apparatus of claim 3, wherein the power line connector is a tap connector to tap the power line.

5. The apparatus of claim 1, further comprising a guide to guide the output cable along a utility pole.

6. The apparatus of claim 5, wherein the guide is a conduit for the output cable to pass therethrough.

7. The apparatus of claim 1, wherein the mobile platform is a truck.

8. The apparatus of claim 1, wherein the mobile platform is a trailer to be towed by a truck.

9. An apparatus comprising:
a mobile platform;
an energy storage unit mounted to the mobile platform, wherein the energy storage unit is to store energy at a utility-scale to be provided to a power distribution network; and
an output cable to connect with a power line of the power distribution network.

10. The apparatus of claim 9, further comprising an inverter to convert a direct current provided by the energy storage unit to alternating current.

11. The apparatus of claim 10, further comprising a transformer mounted to the mobile platform, wherein the transformer is to convert a first voltage from the inverter to a second voltage of the power distribution network.

12. The apparatus of claim 9, wherein the output cable is connected to the power line with a tap connector.

13. The apparatus of claim 9, further comprising a guide to guide the output cable along a utility pole.

14. The apparatus of claim 13, wherein the guide is a conduit for the output cable to pass therethrough.

15. The apparatus of claim 9, wherein the mobile platform is a truck.

16. The apparatus of claim 9, wherein the mobile platform is a trailer to be towed by a truck.

17. An method comprising:
delivering a connection system and a transformer mounted on a mobile platform to a location;
receiving power from an energy storage unit at the connection system;
converting a first voltage provided by the connection system to a second voltage for a power distribution network with the transformer; and
providing the power at the second voltage to the power distribution network via an output cable.

18. The method of claim 17, further comprising converting a direct current provided by the energy storage unit to alternating current with an inverter.

19. The method of claim 17, further comprising connecting the output cable to a power line of the power distribution network with a power line connector disposed on the output cable.

20. The method of claim 19, wherein connecting the output cable comprises tapping the power line.

21-23. (canceled)
